(19) United States
(12) Patent Application Publication
(10) Pub. No.: US 2025/0252885 A1
(43) Pub. Date: Aug. 7, 2025

(54) IMAGING SYSTEM

(71) Applicant: Japan Display Inc., Tokyo (JP)

(72) Inventors: Kazuhiko SAKO, Tokyo (JP); Junji KOBASHI, Tokyo (JP)

(21) Appl. No.: 19/042,411

(22) Filed: Jan. 31, 2025

(30) Foreign Application Priority Data
Feb. 5, 2024 (JP) 2024-015697

(51) Int. Cl. G09G 3/20; H04N 21/431

(52) U.S. Cl. CPC G09G 3/2003; H04N 21/4312; G09G 2310/08; G09G 2320/0666; G09G 2354/00

(57) ABSTRACT

According to an aspect, an imaging system includes: a display device including a display panel; and an imaging device disposed such that the display panel is interposed between the imaging device and a subject, and configured to acquire an image of the subject transmitted through the display panel. One frame period for displaying the image of one frame on the display panel includes a plurality of sub-field periods for displaying different colors. The imaging device is configured to identify a sub-field period for displaying a specific color out of the sub-field periods according to a ratio of a color component or a color difference component of the image acquired in each of the sub-field periods.

### CROSS-REFERENCE TO RELATED APPLICATION

This application claims the benefit of priority from Japanese Patent Application No. 2024-015697 filed on Feb. 5, 2024, the entire contents of which are incorporated herein by reference.

### BACKGROUND

### 1. Technical Field

What is disclosed herein relates to an imaging system.

### 2. Description of the Related Art

Remote conference systems via networks have been widely used. In such a remote conference system, images of a participant taken by a web camera installed or embedded in an upper part of a display monitor, for example, are typically displayed on a screen of each terminal device. In such a configuration, the line of sight of the participant viewing the display monitor does not match the line of sight of the participant displayed on the screen, and the quality of communications may possibly deteriorate. For example, Japanese Patent Application Laid-open Publication No. 2005-176151 (JP-A-2005-176151) discloses a display device with a camera, a communication apparatus, and a communication system in which an imaging module (camera) is incorporated in a display element (display part).

In the conventional technology described in JP-A-2005-176151, display driving of the display element and imaging driving of the imaging module are alternately performed. This configuration may possibly cause flickering in displayed images and captured images, thereby deteriorating the display quality and the imaging quality.

For the foregoing reasons, there is a need for an imaging system that enables remote image display with high quality.

### SUMMARY

According to an aspect, an imaging system includes: a display device including a display panel; and an imaging device disposed such that the display panel is interposed between the imaging device and a subject, and configured to acquire an image of the subject transmitted through the display panel. One frame period for displaying the image of one frame on the display panel includes a plurality of sub-field periods for displaying different colors. The imaging device is configured to identify a sub-field period for displaying a specific color out of the sub-field periods according to a ratio of a color component or a color difference component of the image acquired in each of the sub-field periods.

### BRIEF DESCRIPTION OF THE DRAWINGS

FIG. 1 is a diagram of a schematic configuration of an imaging system according to an embodiment;

FIG. 2 is a schematic circuit diagram of a main configuration of a display device;

FIG. 3 is a schematic sectional view of a display panel;

FIG. 4 is a timing chart of sub-field periods and light emission periods of one frame period for displaying display image data;

FIG. 5 is a diagram of a color filter array of an image sensor;

FIG. 6 is a schematic of an example of the average chromaticity of images acquired in the respective sub-field periods;

FIG. 7 is a conceptual diagram of an example of color components that constitute an object to be imaged;

FIG. 8A is a conceptual diagram of an example of the color components of the image acquired in a first sub-field period;

FIG. 8B is a conceptual diagram of an example of the color components of the image acquired in a second sub-field period;

FIG. 8C is a conceptual diagram of an example of the color components of the image acquired in a third sub-field period;

FIG. 9 is a flowchart of an example of a sub-field period identifying process according to a first embodiment;

FIG. 10 is a conceptual diagram of an example of color difference components that constitute the object to be imaged;

FIG. 11A is a conceptual diagram of an example of the color difference components of the image acquired in the first sub-field period;

FIG. 11B is a conceptual diagram of an example of the color difference components of the image acquired in the second sub-field period;

FIG. 11C is a conceptual diagram of an example of the color difference components of the image acquired in the third sub-field period;

FIG. 12 is a flowchart of an example of the sub-field period identifying process according to a second embodiment; and

FIG. 13 is a timing chart of an example of image acquisition timings in the imaging system according to the embodiment.

### DETAILED DESCRIPTION

The following describes modes (embodiments) for carrying out the present disclosure in detail with reference to the drawings. The present disclosure is not limited to the description of the embodiments to be given below. Components to be described below include those easily conceivable by those skilled in the art or those substantially identical thereto. In addition, the components to be described below can be combined as appropriate. What is disclosed herein is merely an example, and the present disclosure naturally encompasses appropriate modifications easily conceivable by those skilled in the art while maintaining the gist of the disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

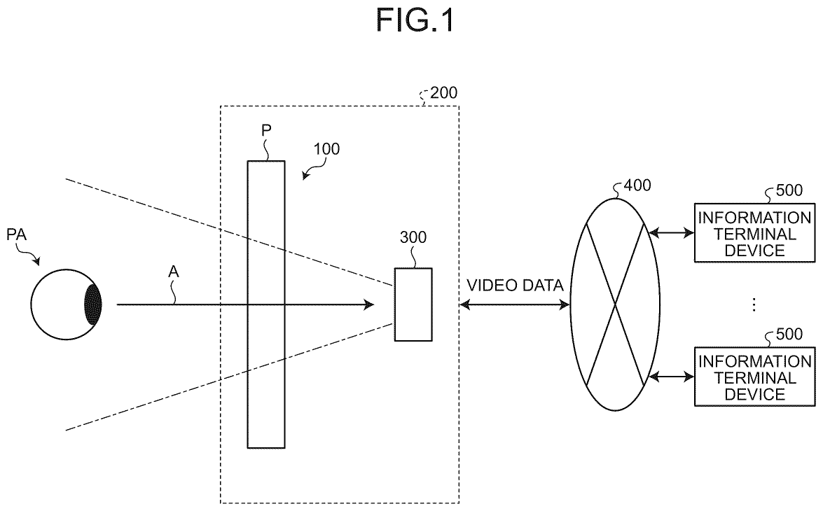

FIG. 1 is a diagram of a schematic configuration of an imaging system according to an embodiment. As illustrated in FIG. 1, an imaging system 200 according to the embodiment includes a display device 100 and an imaging device 300.

The display device 100 according to the present disclosure is a liquid crystal display device that performs display output using what is called a field-sequential color (FSC) method to control pixels such that light rays in a plurality of colors are transmitted through the same pixel at timings different from one another.

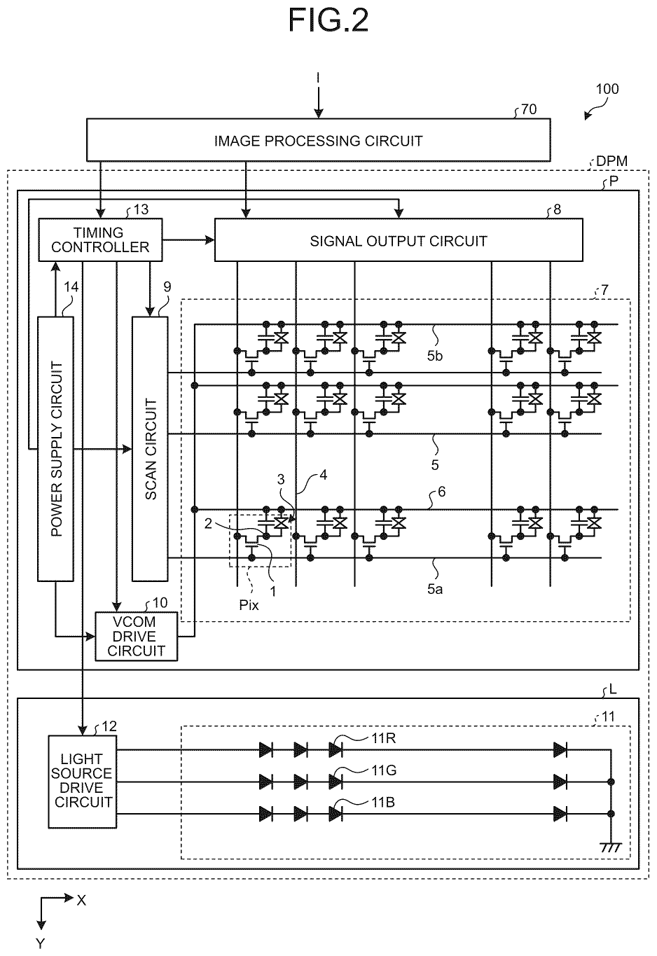

FIG. 2 is a schematic circuit diagram of a main configuration of the display device. The display device 100 includes a display panel module DPM and an image processing circuit 70. The display panel module DPM includes a display panel P and a light source device L.

The display panel P includes a display region 7, a signal output circuit 8, a scan circuit 9, a VCOM drive circuit 10, a timing controller 13, and a power supply circuit 14. One surface of the display panel P where the display region 7 is provided is hereinafter referred to as a display surface, and the other surface is referred to as a back surface. The term “being at the side of the display device 100” means being positioned at the side in a direction intersecting (e.g., orthogonal to) the direction in which the display surface and the back surface face each other with respect to the display device 100.

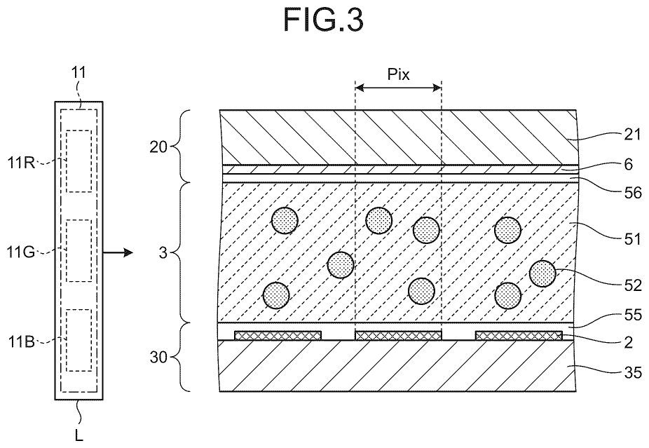

A plurality of pixels Pix are arranged in a matrix in a row-column configuration in the display region 7. Each of the pixels Pix includes a switching element 1 and two electrodes. FIG. 3 is a schematic sectional view of the display panel. In FIGS. 2 and 3, the two electrodes are illustrated as a pixel electrode 2 and a common electrode 6.

The display panel P includes two facing substrates and a liquid crystal 3 sealed between the two substrates. One of the two substrates is hereinafter referred to as a first substrate 30, and the other is referred to as a second substrate 20.

The first substrate 30 includes a light-transmitting glass substrate 35, the pixel electrodes 2 stacked on the second substrate 20 side of the glass substrate 35, and an insulating layer 55 stacked on the second substrate 20 side of the pixel electrodes 2 so as to cover the pixel electrodes 2. The pixel electrode 2 is individually provided for each of the pixels Pix. The second substrate 20 includes a light-transmitting glass substrate 21, the common electrode 6 stacked on the first substrate 30 side of the glass substrate 21, and an insulating layer 56 stacked on the first substrate 30 side of the common electrode 6 so as to cover the common electrode 6. The common electrode 6 has a plate-like or film-like shape shared among the pixels Pix.

The liquid crystal 3 according to a first embodiment is a polymer-dispersed liquid crystal. Specifically, the liquid crystal 3 contains a bulk 51 and fine particles 52. The fine particles 52 change their orientation in the bulk 51 due to the potential difference between the pixel electrodes 2 and the common electrode 6. By individually controlling the potential of the pixel electrode 2 of each of the pixels Pix, the scattering state of the liquid crystal 3 is controlled for each of the pixels Pix.

FIG. 3 illustrates an example where the pixel electrodes 2 and the common electrode 6 are disposed facing each other with the liquid crystal 3 interposed therebetween. The display panel P may be configured with the pixel electrodes 2 and the common electrode 6 provided on a single substrate, and the orientation may change due to the electric field generated by the pixel electrodes 2 and the common electrode 6, thereby controlling the scattering state of the liquid crystal 3.

Next, the mechanism for controlling the potential of the pixel electrode 2 and the common electrode 6 is described.

The switching element 1 is a switching element using, for example, a semiconductor, such as a thin-film transistor (TFT). One of the source and the drain of the switching element 1 is coupled to one of the two electrodes (pixel electrode 2). The other of the source and the drain of the switching element 1 is coupled to a corresponding one of signal lines 4. The gate of the switching element 1 is coupled to a corresponding one of scan lines 5. The scan line 5 applies a potential for opening or closing a circuit between the source and the drain of the switching element 1 under the control of the scan circuit 9. The control of the potential is performed by the scan circuit 9.

In the example illustrated in FIG. 2, the signal lines 4 are arranged along one of the arrangement directions (row direction) of the pixels Pix. The signal lines 4 extend along the other of the arrangement directions (column direction) of the pixels Pix. Each of the signal lines 4 is shared by the switching elements 1 of the corresponding pixels Pix arranged in the column direction. The scan lines 5 are arranged along the column direction. The scan lines 5 extend along the row direction. Each of the scan lines 5 is shared by the switching elements 1 of the corresponding pixels Pix arranged in the row direction.

In the present disclosure, the direction in which the scan line 5 extends is referred to as an X-direction, and the direction in which the scan lines 5 are arranged is referred to as a Y-direction. In FIG. 2, one of the scan lines 5 disposed at opposite ends in the Y-direction is referred to as a scan line 5a, and the other is referred to as a scan line 5b.

The common electrode 6 is coupled to the VCOM drive circuit 10. The VCOM drive circuit 10 applies a common potential to the common electrode 6.

When the scan circuit 9 applies a potential serving as a drive signal to the scan line 5, and the switching elements 1 are controlled to be on, the signal output circuit 8 supplies a pixel signal to the signal line 4 to charge a storage capacitor formed between the pixel electrode 2 and the common electrode 6 and also charge the liquid crystal 3 (fine particles 52) serving as a capacitive load. As a result, a voltage corresponding to the pixel signal is applied between the pixel electrode 2 and the common electrode 6.

After the switching element 1 is turned off, the applied voltage between the pixel electrode 2 and the common electrode 6 is held by the storage capacitor and the liquid crystal 3 (fine particles 52) serving as the capacitive load. The degree of scattering of the liquid crystal 3 (fine particles 52) is controlled according to the applied voltage between the pixel electrode 2 and the common electrode 6 for each of the pixels Pix. The liquid crystal 3 may be, for example, a polymer-dispersed liquid crystal in which the degree of scattering increases as the applied voltage between the pixel electrode 2 and the common electrode 6 for each of the pixels Pix increases or a polymer-dispersed liquid crystal in which the degree of scattering increases as the applied voltage between the pixel electrode 2 and the common electrode 6 for each of the pixels Pix decreases.

As illustrated in FIG. 3, the light source device L is disposed at the side of the display panel P (below the display panel P in FIG. 2). The light source device L includes a light source 11 and a light source drive circuit 12. The light source 11 irradiates the side surface of the display panel P with light. The light source drive circuit 12 controls the light source 11. The light source 11 includes a first light source 11R, a second light source 11G, and a third light source 11B.

Each of the first, the second, and the third light sources 11R, 11G, and 11B emits light under the control of the light source drive circuit 12. Each of the first, the second, and the third light sources 11R, 11G, and 11B is a light source using, for example, a light-emitting element such as a light-emitting diode (LED), but is not limited thereto, and only needs to be a light source controllable in light emission timing.

The light source drive circuit 12 controls the light emission timing of the first, the second, and the third light sources 11R, 11G, and 11B under the control of the timing controller 13. In the present disclosure, the emission color (first color) of the first light source 11R is red (R), the emission color (second color) of the second light source 11G is green (G), and the emission color (third color) of the third light source 11B is blue (B).

When light is emitted from the light source 11, the display region 7 is irradiated with light (first, second, and third colors) incident from one side surface in the Y-direction. Each pixel Pix transmits or scatters light incident from one side surface in the Y-direction. The degree of scattering of the liquid crystal 3 for each of the pixels Pix depends on the state of the liquid crystal 3 controlled according to the pixel signal for each of the pixels Pix.

The timing controller 13 is a circuit that controls the operation timing of the signal output circuit 8, the scan circuit 9, the VCOM drive circuit 10, and the light source drive circuit 12. The timing controller 13 according to the present disclosure operates based on signals input via the image processing circuit 70.

The image processing circuit 70 outputs signals based on display image data I to the signal output circuit 8 and the timing controller 13. When pixel data is data indicating the RGB gradation value assigned to one pixel Pix out of the pixels Pix provided in the display region 7, the display image data I that is input to the image processing circuit 70 to output a display image is a set of pieces of pixel data for the respective pixels Pix in the display region 7. The image processing circuit 70 may be provided to one of the substrates constituting the display panel P, be mounted on flexible printed circuits provided with wiring or the like extending from the display panel P, or be provided outside the display panel P.

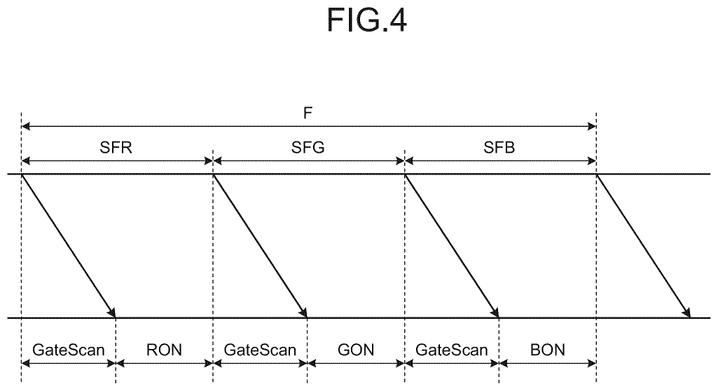

FIG. 4 is a timing chart of sub-field periods and light emission periods of one frame period for displaying the display image data. Specifically, the display device 100 performs display of the display image data I at 60 FPS, for example.

In the display device 100 that performs display output by the FSC system, an image display period of one frame (one frame period) F based on the display image data I is divided into a first sub-field period SFR, a second sub-field period SFG, and a third sub-field period SFB as illustrated in FIG. 4.

In a vertical scanning period GateScan of the first sub-field period SFR, the pixel data corresponding to the output gradation value corresponding to the first color (red (R)) of the display image data I is written for each of the pixels Pix. As a result, the voltage corresponding to the pixel data for each of the pixels Pix is applied to the pixel electrode 2, and the scattering state of the liquid crystal 3 for each of the pixels Pix is controlled according to the applied voltage of the pixel electrode 2.

In the subsequent light emission period RON, the first light source 11R is caused to emit light. In the light emission period RON, light in the first color (red (R)) is scattered and displayed corresponding to the pixel data for each of the pixels Pix written in the previous vertical scanning period GateScan.

In the vertical scanning period GateScan of the second sub-field period SFG, the pixel data corresponding to the output gradation value corresponding to the second color (green (G)) of the display image data I is written for each of the pixels Pix. As a result, the voltage corresponding to the pixel data for each of the pixels Pix is applied to the pixel electrode 2, and the scattering state of the liquid crystal 3 for each of the pixels Pix is controlled according to the applied voltage of the pixel electrode 2.

In the subsequent light emission period GON, the second light source 11G is caused to emit light. In the light emission period GON, light in the second color (green (G)) is scattered and displayed corresponding to the pixel data for each of the pixels Pix written in the previous vertical scanning period GateScan.

In the vertical scanning period GateScan of the third sub-field period SFB, the pixel data corresponding to the output gradation value corresponding to the third color (blue (B)) of the display image data I is written for each of the pixels Pix. As a result, the voltage corresponding to the pixel data for each of the pixels Pix is applied to the pixel electrode 2, and the scattering state of the liquid crystal 3 for each of the pixels Pix is controlled according to the applied voltage of the pixel electrode 2.

In the subsequent light emission period BON, the third light source 11B is caused to emit light. In the light emission period BON, light in the third color (blue (B)) is scattered and displayed corresponding to the pixel data for each of the pixels Pix written in the previous vertical scanning period GateScan.

In the display device 100 with the FSC system described above, an image in which three colors of the first color (red (R)), the second color (green (G)), and the third color (blue (B)) are combined (mixed) is recognized due to the afterimage phenomenon caused by limitation of temporal resolution in the human eye. The display device 100 with the FSC system does not require a color filter for each of the pixels Pix, and thus the light transmittance in the display region 7 can be increased.

In the following description, the first sub-field period SFR, the second sub-field period SFG, and the third sub-field period SFB may be referred to simply as a “sub-field period SF”.

Referring back to FIG. 1, the imaging device 300 is a digital camera including an imaging element, an imaging lens that condenses light onto the imaging element, and other components. While the imaging element is a solid-state imaging element, such as a complementary metal oxide semiconductor (CMOS) image sensor, it is not limited thereto and may be a charge coupled devices (CCD) image sensor, for example.

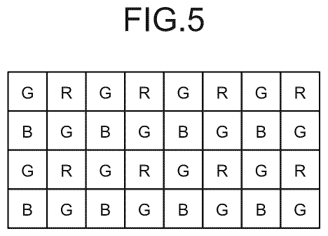

The image sensor includes color filters that selectively transmit the first color (red (R)), the second color (green (G)), and the third color (blue (B)). FIG. 5 is a diagram of a color filter array of the image sensor.

The color filter array of the image sensor illustrated in FIG. 5 is a Bayer array composed of primary color filters of three colors of red (R), green (G), and blue (B) with combinations of four pixels of R/G/G/B arrayed in a regular pattern (specifically, an array in which one first color (red (R)), one third color (blue (B)), and two second colors (green (G)) are arranged in 2×2 pixels in the vertical and horizontal directions). The color filter array of the image sensor illustrated in FIG. 5 is given by way of example only, and the color filter array according to the present disclosure is not limited to the array illustrated in FIG. 5.

Specifically, the color filter array of the image sensor may be, for example, a Bayer array composed of complementary color filters of three colors of yellow (Y), cyan (C), and magenta (M) with combinations of four pixels of C/Y/Y/M arrayed in a regular pattern (an array in which one cyan (C), one magenta (M), and two yellows (Y) are arranged in 2×2 pixels in the vertical and horizontal directions). Alternatively, the color filter array of the image sensor may be, for example, an array in which combinations of four pixels of C/Y/G/M are arrayed in a regular pattern (an array in which one cyan (C), one yellow (Y), one green (G), and one magenta (M) are arranged in 2×2 pixels in the vertical and horizontal directions).

As illustrated in FIG. 1, the display device 100 with the FSC system described above is sandwiched between the imaging device 300 and a subject PA who is a participant in a remote conference system, for example. More preferably, in the imaging system 200 according to the embodiment, the imaging device 300 is provided on an extended line of a line of sight A when the display panel P is viewed from the subject PA.

The image of the subject PA passes through the display panel P, is formed on the imaging element of the imaging device 300, and is captured as image data. In the following description, the subject PA is also referred to as an “object to be imaged”.

The images captured by the imaging device 300 are distributed as video data via a network 400 to information terminal devices 500 of the participants in the remote conference system, for example. Examples of the information terminal device 500 include, but are not limited to, a desktop personal computer, a laptop personal computer, etc. The imaging system 200 according to the embodiment may be composed of a display and a web camera that constitute the information terminal device 500, for example.

In the imaging system 200 according to the embodiment described above, light of the display image data I displayed on the display device 100 may possibly affect the image acquired by the imaging device 300.

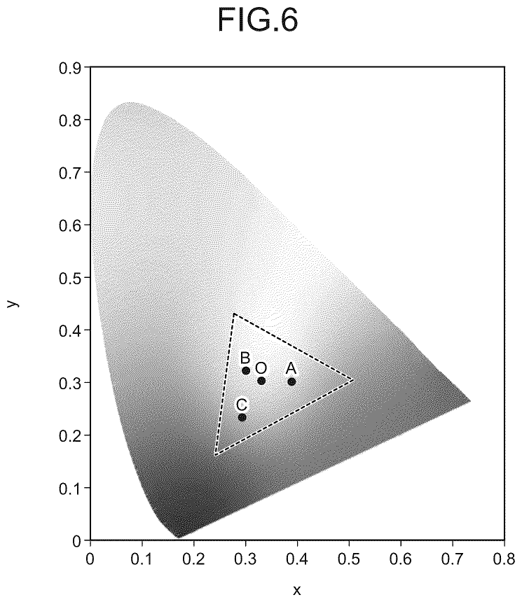

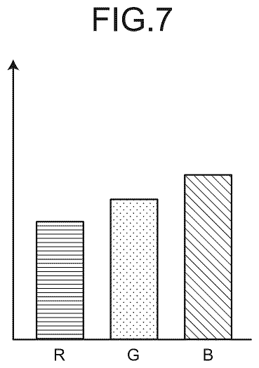

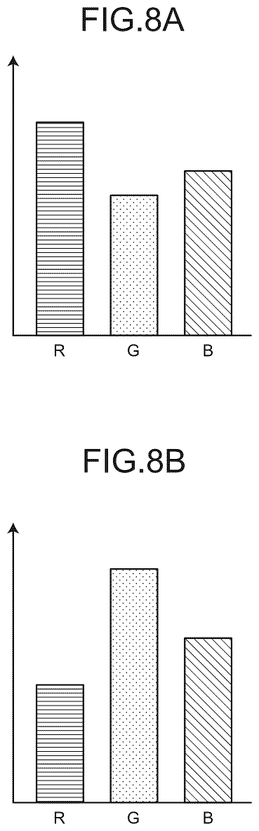

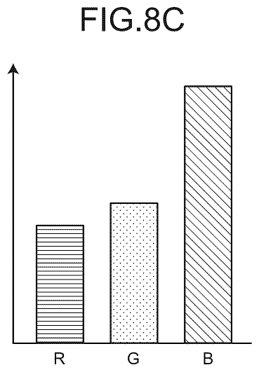

FIG. 6 is a schematic of an example of the average chromaticity of images acquired in the respective sub-field periods. FIG. 7 is a conceptual diagram of an example of color components that constitute the object to be imaged. FIG. 8A is a conceptual diagram of an example of the color components of the image acquired in the first sub-field period. FIG. 8B is a conceptual diagram of an example of the color components of the image acquired in the second sub-field period. FIG. 8C is a conceptual diagram of an example of the color components of the image acquired in the third sub-field period.

FIG. 7 illustrates the color components of R (red), G (green), and B (blue) in the RGB color space. In FIG. 7, the ratio of the R, G, and B components of the object to be imaged is represented in a bar graph extending in the vertical axis direction. In FIG. 8A, the ratio of the R, G, and B components of the image acquired in the first sub-field period SFR is represented in a bar graph extending in the vertical axis direction. In FIG. 8B, the ratio of the R, G, and B components of the image acquired in the second sub-field period SFG is represented in a bar graph extending in the vertical axis direction. In FIG. 8C, the ratio of the R, G, and B components of the image acquired in the third sub-field period SFB is represented in a bar graph extending in the vertical axis direction.

In FIG. 6, the color gamut of the display panel P on the xy chromaticity diagram expressed by the xy coordinates is indicated by a dashed line. Point O in FIG. 6 indicates the original average chromaticity of the image.

Point A in FIG. 6 indicates the average chromaticity of the image acquired in the first sub-field period SFR. As illustrated in FIG. 6, the image acquired in the first sub-field period SFR has an average chromaticity closer to red than the original average chromaticity. Therefore, as illustrated in FIG. 8A, the ratio of the R component is larger than those of the G and B components.

Point B in FIG. 6 indicates the average chromaticity of the image acquired in the second sub-field period SFG. As illustrated in FIG. 6, the image acquired in the second sub-field period SFG has an average chromaticity closer to green than the original average chromaticity. Therefore, as illustrated in FIG. 8B, the ratio of the G component is larger than those of the R and B components.

Point C in FIG. 6 indicates the average chromaticity of the image acquired in the third sub-field period SFB. As illustrated in FIG. 6, the image acquired in the third sub-field period SFB has an average chromaticity closer to blue than the original average chromaticity. Therefore, as illustrated in FIG. 8C, the ratio of the B component is larger than those of the R and G components.

The imaging device 300 according to the present disclosure acquires exposure data in a color different from the display color of the display panel P in each sub-field period SF and generates imaged data by combining the acquired exposure data. This configuration can reduce the effect of light of the display image data I displayed on the display device 100 on the image to be acquired by the imaging device 300, thereby enabling remote image display with high quality. To achieve this, it is first necessary to identify the sub-field period SF in the display panel P. The following describes a sub-field period identifying process according to a first embodiment of the imaging system 200.

### First Embodiment

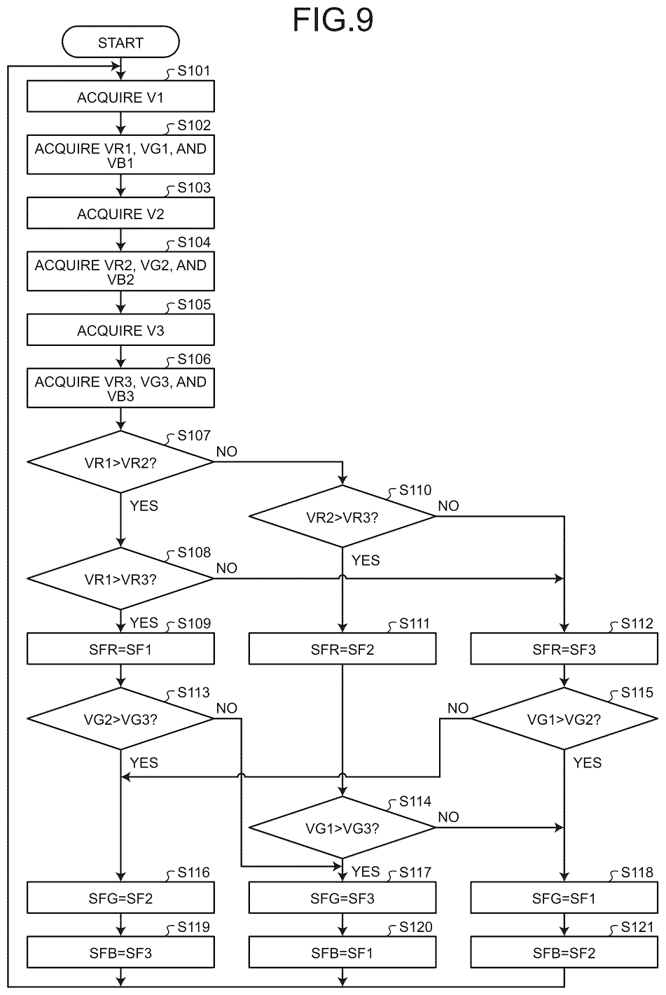

FIG. 9 is a flowchart of an example of the sub-field period identifying process according to the first embodiment. In the present disclosure, it is assumed that the imaging device 300 is supplied with a synchronization signal that defines one sub-field period SF from the timing controller 13 of the display device 100.

In the sub-field period identifying process according to the first embodiment, the imaging device 300 identifies a sub-field period for displaying a specific color out of the sub-field periods SF according to the ratio of the color components of the images acquired in the respective sub-field periods SF.

Specifically, in a certain sub-field period SF1, the imaging device 300 acquires first image data V1 (Step S101) and acquires an R component VR1 (first color component), a G component VG1 (second color component), and a B component VB1 (third color component) of the acquired first image data V1 (Step S102).

In the subsequent sub-field period SF2, the imaging device 300 acquires second image data V2 (Step S103) and acquires an R component VR2 (first color component), a G component VG2 (second color component), and a B component VB2 (third color component) of the acquired second image data V2 (Step S104).

In the subsequent sub-field period SF3, the imaging device 300 acquires third image data V3 (Step S105) and acquires an R component VR3 (first color component), a G component VG3 (second color component), and a B component VB3 (third color component) of the acquired third image data V3 (Step S106).

The imaging device 300 identifies the sub-field period SF in which the image data with the largest R component (first color component) is acquired, as the first sub-field period SFR out of the three sub-field periods SF.

Specifically, the imaging device 300 determines whether the R component VR1 of the first image data V1 is larger than the R component VR2 of the second image data V2 (Step S107).

If the R component VR1 of the first image data V1 is larger than the R component VR2 of the second image data V2 (Yes at Step S107), the imaging device 300 then determines whether the R component VR1 of the first image data V1 is larger than the R component VR3 of the third image data V3 (Step S108).

If the R component VR1 of the first image data V1 is larger than the R component VR3 of the third image data V3 (Yes at Step S108), the imaging device 300 identifies the sub-field period SF1 as the first sub-field period SFR (Step S109).

If the condition at Step S107 is not satisfied (No at Step S107), the imaging device 300 then determines whether the R component VR2 of the second image data V2 is larger than the R component VR3 of the third image data V3 (Step S110).

If the R component VR2 of the second image data V2 is larger than the R component VR3 of the third image data V3 (Yes at Step S110), the imaging device 300 identifies the sub-field period SF2 as the first sub-field period SFR (Step S111).

If the condition at Step S108 is not satisfied (No at Step S108) or if the condition at Step S110 is not satisfied (No at Step S110), the imaging device 300 identifies the sub-field period SF3 as the first sub-field period SFR (Step S112).

After the processing from Step S107 to Step S112 described above, the imaging device 300 then identifies the sub-field period SF in which the image data with the largest G component (second color component) is acquired, as the second sub-field period SFG out of the two remaining sub-field periods SF.

Specifically, if the sub-field period SF1 is determined to be the first sub-field period SFR (Step S109), the imaging device 300 determines whether the G component VG2 of the second image data V2 is larger than the G component VG3 of the third image data V3 (Step S113).

If the sub-field period SF2 is determined to be the first sub-field period SFR (Step S111), the imaging device 300 then determines whether the G component VG1 of the first image data V1 is larger than the G component VG3 of the third image data V3 (Step S114).

If the sub-field period SF3 is determined to be the first sub-field period SFR (Step S112), the imaging device 300 then determines whether the G component VG1 of the first image data V1 is larger than the G component VG2 of the second image data V2 (Step S115).

If the G component VG2 of the second image data V2 is larger than the G component VG3 of the third image data V3 (Yes at Step S113) or if the condition at Step S115 is not satisfied (No at Step S115), the imaging device 300 identifies the sub-field period SF2 as the second sub-field period SFG (Step S116).

If the G component VG1 of the first image data V1 is larger than the G component VG3 of the third image data V3 (Yes at Step S114) or if the condition at Step S113 is not satisfied (No at Step S113), the imaging device 300 identifies the sub-field period SF3 as the second sub-field period SFG (Step S117).

If the G component VG1 of the first image data V1 is larger than the G component VG2 of the second image data V2 (Yes at Step S115) or if the condition at Step S114 is not satisfied (No at Step S114), the imaging device 300 identifies the sub-field period SF1 as the second sub-field period SFG (Step S118).

After the processing from Step S113 to Step S118 described above, the imaging device 300 then identifies the remaining sub-field period SF as the third sub-field period SFB.

Specifically, if the sub-field period SF1 is identified as the first sub-field period SFR (Step S109) and the sub-field period SF2 is identified as the second sub-field period SFG (Step S116), the imaging device 300 identifies the remaining sub-field period SF3 as the third sub-field period SFB (Step S119).

If the sub-field period SF2 is identified as the first sub-field period SFR (Step S111) and the sub-field period SF3 is identified as the second sub-field period SFG (Step S117), the imaging device 300 identifies the remaining sub-field period SF1 as the third sub-field period SFB (Step S120).

If the sub-field period SF3 is identified as the first sub-field period SFR (Step S112) and the sub-field period SF1 is identified as the second sub-field period SFG (Step S118), the imaging device 300 identifies the remaining sub-field period SF2 as the third sub-field period SFB (Step S121).

After the sub-field periods are identified by executing the sub-field period identifying process according to the first embodiment described above, the sub-field period identifying process according to the first embodiment may be omitted in the next and subsequent frame periods if the order of the sub-field periods SF is determined in advance. Furthermore, if the order of the sub-field periods SF is the first sub-field period SFR, the second sub-field period SFG, and the third sub-field period SFB, the processing from Step S113 to Step S121 may be omitted. In this case, after the sub-field periods are identified in the first frame period F by executing the processing from Step S101 to Step S112 of the sub-field period identifying process according to the first embodiment described above, the sub-field period identifying process according to the first embodiment may be omitted in the next and subsequent frame periods.

When the imaging device 300 performs the sub-field period identifying process according to the first embodiment described above, the display device 100 may display the display image data I as an all-white image with a luminance of 100% at least in the three sub-field periods in which the imaging device 300 performs the sub-field period identifying process. This configuration can increase the degree of light scattering in each sub-field period SF and clarify the difference between the color components acquired in each sub-field period SF.

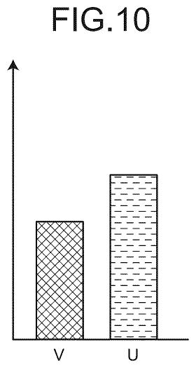

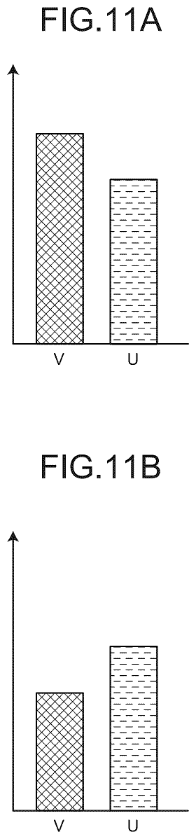

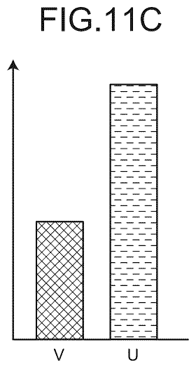

FIG. 10 is a conceptual diagram of an example of color difference components that constitute the object to be imaged. FIG. 11A is a conceptual diagram of an example of the color difference components of the image acquired in the first sub-field period. FIG. 11B is a conceptual diagram of an example of the color difference components of the image acquired in the second sub-field period. FIG. 11C is a conceptual diagram of an example of the color difference components of the image acquired in the third sub-field period.

FIG. 10 illustrates the color difference components of U (difference between the luminance and the blue component) and V (difference between the luminance and the red component) in the YUV color space. In FIG. 10, the ratio of the V and U components of the object to be imaged is represented in a bar graph extending in the vertical axis direction. In FIG. 11A, the ratio of the V and U components of the image acquired in the first sub-field period SFR is represented in a bar graph extending in the vertical axis direction. In FIG. 11B, the ratio of the V and U components of the image acquired in the second sub-field period SFG is represented in a bar graph extending in the vertical axis direction. In FIG. 11C, the ratio of the V and U components of the image acquired in the third sub-field period SFB is represented in a bar graph extending in the vertical axis direction.

As described above, the image acquired in the first sub-field period SFR has an average chromaticity closer to red than the original average chromaticity. Therefore, as illustrated in FIG. 11A, the ratio of the V component is larger than that of the U component.

The image acquired in the third sub-field period SFB has an average chromaticity closer to blue than the original average chromaticity. Therefore, as illustrated in FIG. 11C, the ratio of the U component is larger than that of the V component.

The following describes a sub-field period identifying process according to a second embodiment of the imaging system 200.

### Second Embodiment

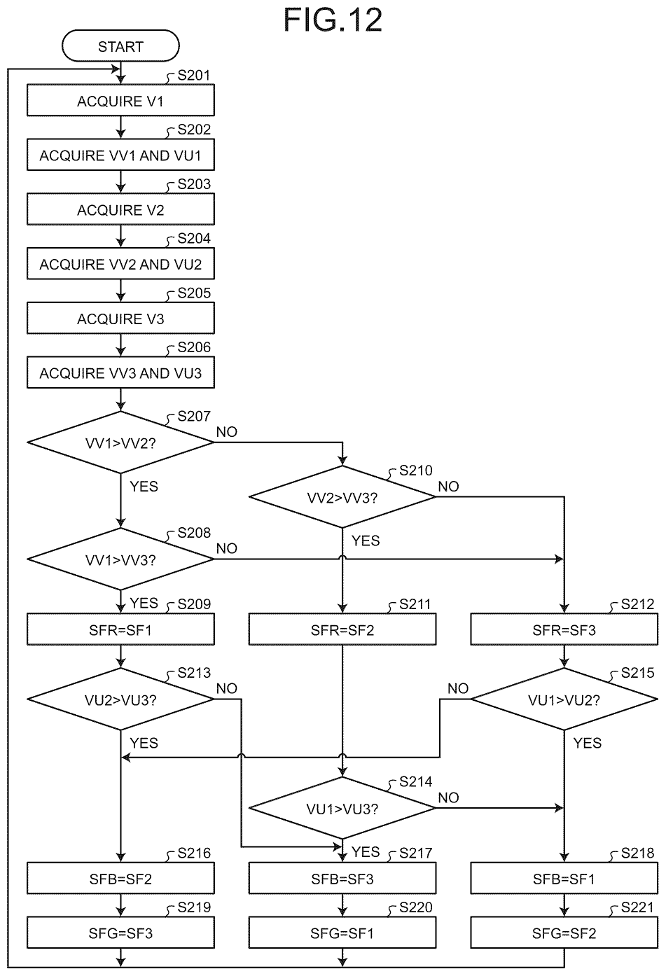

FIG. 12 is a flowchart of an example of the sub-field period identifying process according to the second embodiment. In the present disclosure, it is assumed that the imaging device 300 is supplied with a synchronization signal that defines one sub-field period SF from the timing controller 13 of the display device 100.

In the sub-field period identifying process according to the second embodiment, the imaging device 300 identifies a sub-field period for displaying a specific color out of the sub-field periods SF based on the ratio of the color difference components of the images acquired in the respective sub-field periods SF.

Specifically, in a certain sub-field period SF1, the imaging device 300 acquires first image data V1 (Step S201) and acquires a V component VV1 (first color difference component) and a U component VU1 (second color difference component) of the acquired first image data V1 (Step S202).

In the subsequent sub-field period SF2, the imaging device 300 acquires second image data V2 (Step S203) and acquires a V component VV2 (first color difference component) and a U component VU2 (second color difference component) of the acquired second image data V2 (Step S204).

In the subsequent sub-field period SF3, the imaging device 300 acquires third image data V3 (Step S205) and acquires a V component VV3 (first color difference component) and a U component VU3 (second color difference component) of the acquired third image data V3 (Step S206).

The imaging device 300 identifies the sub-field period SF in which the image data with the largest V component (first color difference component) is acquired, as the first sub-field period SFR out of the three sub-field periods SF.

Specifically, the imaging device 300 determines whether the V component VV1 of the first image data V1 is larger than the V component VV2 of the second image data V2 (Step S207).

If the V component VV1 of the first image data V1 is larger than the V component VV2 of the second image data V2 (Yes at Step S207), the imaging device 300 then determines whether the V component VV1 of the first image data V1 is larger than the V component VV3 of the third image data V3 (Step S208).

If the V component VV1 of the first image data V1 is larger than the V component VV3 of the third image data V3 (Yes at Step S208), the imaging device 300 identifies the sub-field period SF1 as the first sub-field period SFR (Step S209).

If the condition at Step S207 is not satisfied (No at Step S207), the imaging device 300 then determines whether the V component VV2 of the second image data V2 is larger than the V component VV3 of the third image data V3 (Step S210).

If the V component VV2 of the second image data V2 is larger than the V component VV3 of the third image data V3 (Yes at Step S210), the imaging device 300 identifies the sub-field period SF2 as the first sub-field period SFR (Step S211).

If the condition at Step S108 is not satisfied (No at Step S208) or if the condition at Step S210 is not satisfied (No at Step S210), the imaging device 300 identifies the sub-field period SF3 as the first sub-field period SFR (Step S212).

After the processing from Step S207 to Step S212 described above, the imaging device 300 then identifies the sub-field period SF in which the image data with the largest U component (second color difference component) is acquired, as the third sub-field period SFB out of the two remaining sub-field periods SF.

Specifically, if the sub-field period SF1 is identified as the first sub-field period SFR (Step S209), the imaging device 300 determines whether the U component VU2 of the second image data V2 is larger than the U component VU3 of the third image data V3 (Step S213).

If the sub-field period SF2 is identified as the first sub-field period SFR (Step S211), the imaging device 300 determines whether the U component VU1 of the first image data V1 is larger than the U component VU3 of the third image data V3 (Step S214).

If the sub-field period SF3 is identified as the first sub-field period SFR (Step S212), the imaging device 300 determines whether the U component VU1 of the first image data V1 is larger than the U component VU2 of the second image data V2 (Step S215).

If the U component VU2 of the second image data V2 is larger than the U component VU3 of the third image data V3 (Yes at Step S213) or if the condition at Step S215 is not satisfied (No at Step S215), the imaging device 300 identifies the sub-field period SF2 as the third sub-field period SFB (Step S216).

If the U component VU1 of the first image data V1 is larger than the U component VU3 of the third image data V3 (Yes at Step S214) or if the condition at Step S213 is not satisfied (No at Step S213), the imaging device 300 identifies the sub-field period SF3 as the third sub-field period SFB (Step S217).

If the U component VU1 of the first image data V1 is larger than the U component VU2 of the second image data V2 (Yes at Step S215) or if the condition at Step S214 is not satisfied (No at Step S214), the imaging device 300 identifies the sub-field period SF1 as the third sub-field period SFB (Step S218).

After the processing from Step S213 to Step S218 described above, the imaging device 300 then identifies the remaining sub-field period SF as the second sub-field period SFG.

Specifically, if the sub-field period SF1 is identified as the first sub-field period SFR (Step S209) and the sub-field period SF2 is identified as the third sub-field period SFB (Step S216), the imaging device 300 identifies the remaining sub-field period SF3 as the second sub-field period SFG (Step S219).

If the sub-field period SF2 is identified as the first sub-field period SFR (Step S211) and the sub-field period SF3 is identified as the third sub-field period SFB (Step S217), the imaging device 300 identifies the remaining sub-field period SF1 as the second sub-field period SFG (Step S220).

If the sub-field period SF3 is identified as the first sub-field period SFR (Step S212) and the sub-field period SF1 is identified as the third sub-field period SFB (Step S218), the imaging device 300 identifies the remaining sub-field period SF2 as the second sub-field period SFG (Step S221).

After the sub-field periods are identified by executing the sub-field period identifying process according to the second embodiment described above, the sub-field period identifying process according to the second embodiment may be omitted in the next and subsequent frame periods if the order of the sub-field periods SF is determined in advance. Furthermore, if the order of the sub-field periods SF is the first sub-field period SFR, the second sub-field period SFG, and the third sub-field period SFB, the processing from Step S213 to Step 221 may be omitted. In this case, after the sub-field periods are identified in the first frame period F by executing the processing from Step S201 to Step S212 of the sub-field period identifying process according to the second embodiment described above, the sub-field period identifying process according to the second embodiment may be omitted in the next and subsequent frame periods.

When the imaging device 300 performs the sub-field period identifying process according to the second embodiment described above, the display device 100 may display the display image data I as an all-white image with a luminance of 100% at least in the three sub-field periods in which the imaging device 300 performs the sub-field period identifying process. This configuration can increase the degree of light scattering in each sub-field period SF and clarify the difference between the color difference components acquired in each sub-field period SF.

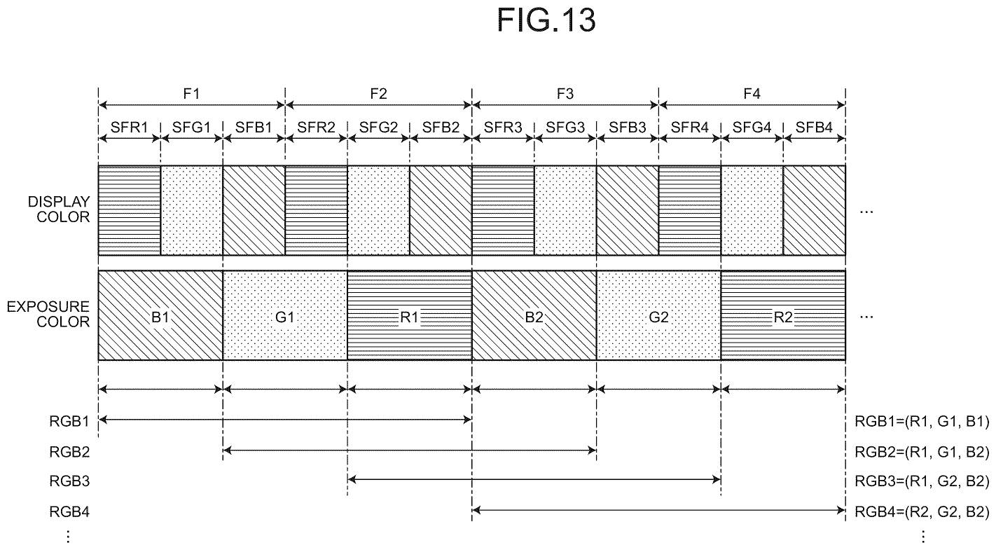

The following describes the image acquisition method in the imaging system 200 according to the embodiment. FIG. 13 is a timing chart of an example of image acquisition timings in the imaging system according to the embodiment.

In the example illustrated in FIG. 13, the image display timings in the display device 100 are the same as the timing chart described with reference to FIG. 4. In other words, an image display period of one frame (one frame period F) is divided into the first sub-field period SFR, the second sub-field period SFG, and the third sub-field period SFB. In the following description, the sub-field periods SF are assumed to have already been identified by the sub-field period identifying process according to the first and the second embodiments described above.

FIG. 13 illustrates frame periods F1, F2, F3, and F4 of four frames. In the frame period F1, the first sub-field period is SFR1, the second sub-field period is SFG1, and the third sub-field period is SFB1.

In the frame period F2, the first sub-field period is SFR2, the second sub-field period is SFG2, and the third sub-field period is SFB2.

In the frame period F3, the first sub-field period is SFR3, the second sub-field period is SFG3, and the third sub-field period is SFB3.

In the frame period F4, the first sub-field period is SFR4, the second sub-field period is SFG4, and the third sub-field period is SFB4.

In the example illustrated in FIG. 13, the imaging device 300 first acquires exposure data B1 of the third color (blue (B)) different from the display colors (the first color (red (R)) and the second color (green (G))) in two sub-field periods of the first sub-field period SFR1 of the frame period F1 in which the first color (red (R)) is displayed by the display device 100 and the second sub-field period SFG1 in which the second color (green (G)) is displayed.

Subsequently, the imaging device 300 acquires exposure data G1 of the second color (green (G)) different from the display colors (the third color (blue (B)) and the first color (red (R))) in two sub-field periods of the third sub-field period SFB1 of the frame period F1 in which the third color (blue (B)) is displayed by the display device 100 and the first sub-field period SFR2 of the frame period F2 in which the first color (red (R)) is displayed.

Subsequently, the imaging device 300 acquires exposure data R1 of the first color (red (R)) different from the display colors (the second color (green (G)) and the third color (blue (B))) in two sub-field periods of the second sub-field period SFG2 of the frame period F2 in which the second color (green (G)) is displayed by the display device 100 and the third sub-field period SFB2 in which the third color (blue (B)) is displayed.

The imaging device 300 generates imaged data RGB1 (=R1, G1, B1) by combining the exposure data R1 of the first color (red (R)), the exposure data G1 of the second color (green (G)), and the exposure data B1 of the third color (blue (B)).

Subsequently, the imaging device 300 acquires exposure data B2 of the third color (blue (B)) different from the display colors (the first color (red (R)) and the second color (green (G))) in two sub-field periods of the first sub-field period SFR3 of the frame period F3 in which the first color (red (R)) is displayed by the display device 100 and the second sub-field period SFG3 in which the second color (green (G)) is displayed.

The imaging device 300 generates imaged data RGB2 (=R1, G1, B2) by combining the exposure data R1 of the first color (red (R)), the exposure data G1 of the second color (green (G)), and the exposure data B2 of the third color (blue (B)).

Subsequently, the imaging device 300 acquires exposure data G2 of the second color (green (G)) different from the display colors (the third color (blue (B)) and the first color (red (R))) in two sub-field periods of the third sub-field period SFB3 of the frame period F3 in which the third color (blue (B)) is displayed by the display device 100 and the first sub-field period SFR4 of the frame period F4 in which the first color (red (R)) is displayed.

The imaging device 300 generates imaged data RGB3 (=R1, G2, B2) by combining the exposure data R1 of the first color (red (R)), the exposure data G2 of the second color (green (G)), and the exposure data B2 of the third color (blue (B)).

Subsequently, the imaging device 300 acquires exposure data R2 of the first color (red (R)) different from the display colors (the second color (green (G)) and the third color (blue (B))) in two sub-field periods of the second sub-field period SFG4 of the frame period F4 in which the second color (green (G)) is displayed by the display device 100 and the third sub-field period SFB4 in which the third color (blue (B)) is displayed.

The imaging device 300 generates imaged data RGB4 (=R2, G2, B2) by combining the exposure data R2 of the first color (red (R)), the exposure data G2 of the second color (green (G)), and the exposure data B2 of the third color (blue (B)).

In the same manner thereafter, the imaging device 300 acquires imaged data RGB5, RGB6, With this configuration, when the display device 100 displays the display image data I at 60 FPS, for example, the imaging device 300 can capture the images of the object to be imaged at 90 FPS.

As described above, in the imaging system 200 according to the embodiment, the imaging device 300 acquires the exposure data in a color different from the display color of the display panel P in each sub-field period SF and generates the imaged data by combining the acquired exposure data. This configuration can reduce the effect of light of the display image data I displayed on the display device 100 on the image to be acquired by the imaging device 300, thereby enabling remote image display with high quality.

The first embodiment has described the configuration that identifies a sub-field period for displaying a specific color out of the sub-field periods SF using the components in the RGB color space of the images acquired in the respective sub-field periods SF as the parameters. The second embodiment has described the configuration that identifies a sub-field period for displaying a specific color out of the sub-field periods SF using the components in the YUV color space of the images acquired in the respective sub-field periods SF as the parameters. However, the color space used to identify a sub-field period for displaying a specific color out of the sub-field periods SF is not limited to the RGB color space or the YUV color space. Specifically, for example, a sub-field period for displaying a specific color may be identified out of the sub-field periods SF using x and y of the xy chromaticity as the parameters. Alternatively, for example, a sub-field period for displaying a specific color may be identified out of the sub-field periods SF using u and v of the uv chromaticity or u′ and v′ of the u′v′ chromaticity as the parameters. Still alternatively, for example, a sub-field period for displaying a specific color may be identified out of the sub-field periods SF using Hue (hue) in the HSV color space or h (hue angle) in the L*C*h color space as the parameters.

Although the preferred embodiments of the present disclosure have been described above, the present disclosure is not limited to the embodiments described above. The content disclosed in the embodiments is merely an example, and can be variously modified within the scope not departing from the gist of the present disclosure. For example, any modifications appropriately made within the scope not departing from the gist of the present disclosure also naturally belong to the technical scope of the present invention.

What is claimed is:

1. An imaging system comprising:
a display device comprising a display panel; and
an imaging device disposed such that the display panel is interposed between the imaging device and a subject, and configured to acquire an image of the subject transmitted through the display panel, wherein
one frame period for displaying the image of one frame on the display panel includes a plurality of sub-field periods for displaying different colors, and
the imaging device is configured to identify a sub-field period for displaying a specific color out of the sub-field periods according to a ratio of a color component or a color difference component of the image acquired in each of the sub-field periods.

2. The imaging system according to claim 1, wherein
the sub-field periods include:
a first sub-field period for displaying a first color;
a second sub-field period for displaying a second color; and
a third sub-field period for displaying a third color.

3. The imaging system according to claim 2, wherein
the display device comprises a light source configured to irradiate a side surface of the display panel with light, and
the light source comprises:
a first light source configured to emit light in the first sub-field period;
a second light source configured to emit light in the second sub-field period; and
a third light source configured to emit light in the third sub-field period.

4. The imaging system according to claim 3, wherein
the first color is red,
the second color is green, and
the third color is blue.

5. The imaging system according to claim 2, wherein the imaging device is configured to
acquire a first color component corresponding to the first color in three consecutive sub-field periods and
identify, as the first sub-field period, the sub-field period in which an image having the first color component that is largest is acquired.

6. The imaging system according to claim 5, wherein the imaging device is configured to
acquire a second color component corresponding to the second color in the three sub-field periods in which the first color component is acquired and
identify the sub-field period in which an image having the second color component that is larger is acquired, as the second sub-field period out of the two sub-field periods other than the sub-field period identified as the first sub-field period.

7. The imaging system according to claim 5, wherein the display device is conjured to display an all-white image in at least the three sub-field periods in which the imaging device acquires the first color component.

8. The imaging system according to claim 2, wherein the imaging device is configured to
acquire a first color difference component corresponding to the first color in three consecutive sub-field periods and
identify, as the first sub-field period, the sub-field period in which the image having the first color difference component that is largest is acquired.

9. The imaging system according to claim 8, wherein the imaging device is configured to
acquire a second color difference component corresponding to the third color in the three sub-field periods in which the first color difference component is acquired and
identify the sub-field period in which the image having the second color difference component that is larger is acquired, as the third sub-field period out of the two sub-field periods other than the sub-field period identified as the first sub-field period.

10. The imaging system according to claim 8, wherein the display device is configured to display an all-white image in at least the three sub-field periods in which the imaging device acquires the first color difference component.

11. The imaging system according to claim 5, wherein the imaging device is configured to combine a plurality of pieces of exposure data of a plurality of colors acquired in the sub-field periods to generate imaged data.

12. The imaging system according to claim 8, wherein the imaging device is configured to combine a plurality of pieces of exposure data of a plurality of colors acquired in the sub-field periods to generate imaged data.

13. The imaging system according to claim 11, wherein
the imaging device is configured to acquire the exposure data of a color different from the first color in the first sub-field period,
the imaging device is configured to acquire the exposure data of a color different from the second color in the second sub-field period, and
the imaging device is configured to acquire the exposure data of a color different from the third color in the third sub-field period.

14. The imaging system according to claim 12, wherein
the imaging device is configured to acquire the exposure data of a color different from the first color in the first sub-field period,
the imaging device is configured to acquire the exposure data of a color different from the second color in the second sub-field period, and
the imaging device is configured to acquire the exposure data of a color different from the third color in the third sub-field period.
